(19) United States
(12) Patent Application Publication
(10) Pub. No.: US 2012/0188566 A1
(43) Pub. Date: Jul. 26, 2012

(54) PRINTING APPARATUS AND PROCESSING METHOD THEREOF

(75) Inventor: Akiteru Naka, Machida-shi (JP)

(73) Assignee: CANON KABUSHIKI KAISHA, Tokyo (JP)

(21) Appl. No.: 13/345,058

(22) Filed: Jan. 6, 2012

(30) Foreign Application Priority Data
Jan. 26, 2011 (JP) 2011-014386

(51) Int. Cl. H04N 1/60

(52) U.S. Cl. 358/1.9

(57) ABSTRACT

A printing apparatus comprising: a reception unit configured to receive print data; an image processing unit configured to execute rendering processing based on page data generated from the print data and rasterize the page data into image data; a storage unit configured to store the image data rasterized by the image processing unit; and a control unit configured to, when a free area in the storage unit runs short in rasterization of first print data into image data, delete, from the storage unit, image data of second print data which designates a printing medium different from a printing medium on which the first print data is to be printed.

### BACKGROUND OF THE INVENTION

1. Field of the Invention

The present invention relates to a printing apparatus and processing method thereof.

2. Description of the Related Art

A printing apparatus has conventionally been known that prints using a printing medium such as continuous paper (for example, roll paper). Even when the printing apparatus handles roll paper, it performs interrupt printing for a high-priority job to interrupt the current job and print based on the high-priority job. If interruption of a print job is performed, the print job is handled as an interrupt job and processed preferentially to a normal print job. More specifically, even the interrupt job undergoes a series of processes of rendering (to be referred to as RIPing) the interrupt job, storing it in a hard disk drive (to be referred to as an HDD), and printing. However, the interrupt job is processed prior to a previously input normal job so as to print as quickly as possible.

A print job is formed from a file in a PDL (Page Description Language) format such as PDF (Portable Document Format) or XPS (XML Paper Specification). When a print job of this format is input, RIP sometimes takes time. It is therefore common practice to input a job and complete RIP in advance during the night, and perform print processing immediately when the operator comes in the morning.

During the night, RIP is executed until the HDD becomes full (to be referred to as hold). If an interrupt job is input after RIP is performed during the night until the HDD becomes full, RIP of the interrupt job cannot start quickly because no free area is left to store RIPed data in the HDD.

The time taken for RIP depends on the complexity of a PDL file. To stably print, hold is used not only during the night but also in various situations.

Exhaustion of the HDD can be prevented by increasing the HDD capacity. However, the RIPed data size tends to be larger year after year. The problem cannot be solved by simply increasing the HDD capacity.

RIPed data is deleted from the HDD or the like after printing. However, for example, printing of a plurality of copies does not complete so quickly, and RIP of an interrupt job cannot start soon.

Japanese Patent Laid-Open No. 2007-245703 discloses a technique of, when an area large enough to store image data rasterized based on an interrupt job cannot be ensured in the HDD, canceling a previously input job to ensure the area. Japanese Patent Laid-Open No. 2006-088364 discloses a technique of registering an interrupt job at the end of currently registered print jobs as a method of processing a requested interrupt job during printing on roll paper.

However, the method in Japanese Patent Laid-Open No. 2007-245703 does not consider interruption in printing using roller paper. For example, for printing on roller paper, RIP takes time and a large amount of image data is stored in the HDD, as described above. In printing using roller paper, when there is no free area in the HDD at the timing when an interrupt job is input, a free area for storing image data based on an interrupt job needs to be ensured in the HDD. However, the method in Japanese Patent Laid-Open No. 2007-245703 does not take account of this processing. In addition, this method does not fully examine a job to be canceled among a plurality of previously input print jobs.

The method in Japanese Patent Laid-Open No. 2006-088364 considers neither a method of quickly processing an interrupt job nor a processing method when an area to store image data rasterized based on a print job cannot be ensured.

### SUMMARY OF THE INVENTION

The present invention provides a technique capable of quickly executing high-priority printing even if there is no free area when high-priority printing is requested.

According to a first aspect of the present invention, there is provided a printing apparatus comprising: a reception unit configured to receive print data; an image processing unit configured to execute rendering processing based on page data generated from the print data and rasterize the page data into image data; a storage unit configured to store the image data rasterized by the image processing unit; and a control unit configured to, when a free area in the storage unit runs short in rasterization of first print data into image data, delete, from the storage unit, image data of second print data which designates a printing medium different from a printing medium on which the first print data is to be printed.

According to a second aspect of the present invention, there is provided a printing apparatus comprising: a reception unit configured to receive print data; a determination unit configured to determine priority of the print data; a page data storage unit configured to store page data obtained by dividing the print data received by the reception unit into pages; an image processing unit configured to execute rendering processing based on the page data and rasterize the page data into image data; an image data storage unit configured to store the image data rasterized by the image processing unit; and a control unit configured to, when a free area in the image data storage unit runs short in rasterization of first print data into image data, simultaneously delete, from the page data storage unit and the image data storage unit, page data obtained by dividing second print data lower in priority than the first print data, and image data rasterized from the page data.

According to a third aspect of the present invention, there is provided a processing method for a printing apparatus, comprising: receiving print data; executing rendering processing based on page data generated from the print data to rasterize the page data into image data; storing, in a storage unit, the image data rasterized in the executing rendering processing; and when a free area in the storage unit runs short in rasterization of first print data into image data, deleting, from the storage unit, image data of second print data which designates a printing medium different from a printing medium on which the first print data is to be printed.

According to a fourth aspect of the present invention, there is provided a processing method for a printing apparatus, comprising: receiving print data; determining priority of the print data; dividing the print data received in the receiving print data into pages to store the divided print data as page data in a page storage unit; executing rendering processing based on the page data to rasterize the page data into image data in an image data storage unit; and when a free area in the image data storage unit runs short in rasterization of first print data into image data, simultaneously deleting, from the page data storage unit and the image data storage unit, page data obtained by dividing second print data lower in priority than the first print data, and image data rasterized from the page data.

Further features of the present invention will be apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a view exemplifying the arrangement of a printing apparatus 100 according to an embodiment of the present invention;

FIG. 2 is a block diagram exemplifying a hardware configuration in a control unit 108 shown in FIG. 1;

FIG. 3 is a flowchart exemplifying a processing sequence in the printing apparatus 100 shown in FIG. 1;

FIG. 4 is a block diagram exemplifying a functional arrangement implemented by the control unit 108 shown in FIG. 1;

FIGS. 5A and 5B are views exemplifying a print job control method;

FIGS. 6A and 6B are charts showing a sequence chart when printing is performed based on a print job;

FIG. 7 is a view exemplifying a print job control method;

FIGS. 8A and 8B are charts showing a sequence chart when printing is performed based on a print job;

FIG. 9 is a flowchart exemplifying a processing sequence in the printing apparatus 100 shown in FIG. 1;

FIG. 10 is a flowchart exemplifying a processing sequence in the printing apparatus 100 shown in FIG. 1;

FIG. 11 is a flowchart exemplifying a processing sequence in the printing apparatus 100 shown in FIG. 1;

FIG. 12 is a block diagram exemplifying a functional arrangement implemented by a control unit 108 according to the second embodiment; and

FIG. 13 is a flowchart exemplifying a processing sequence in a printing apparatus 100 according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

Embodiments of the present invention will be described in detail below with reference to the accompanying drawings. In the following description, an inkjet printing apparatus will be exemplified. The printing apparatus may be, for example, a single-function printer having only a print function, or a multifunction printer having a plurality of functions such as a print function, FAX function, and scanner function. Also, the printing apparatus may be, for example, a manufacturing apparatus used to manufacture a color filter, electronic device, optical device, micro-structure, or the like according to a predetermined printing method.

### First Embodiment

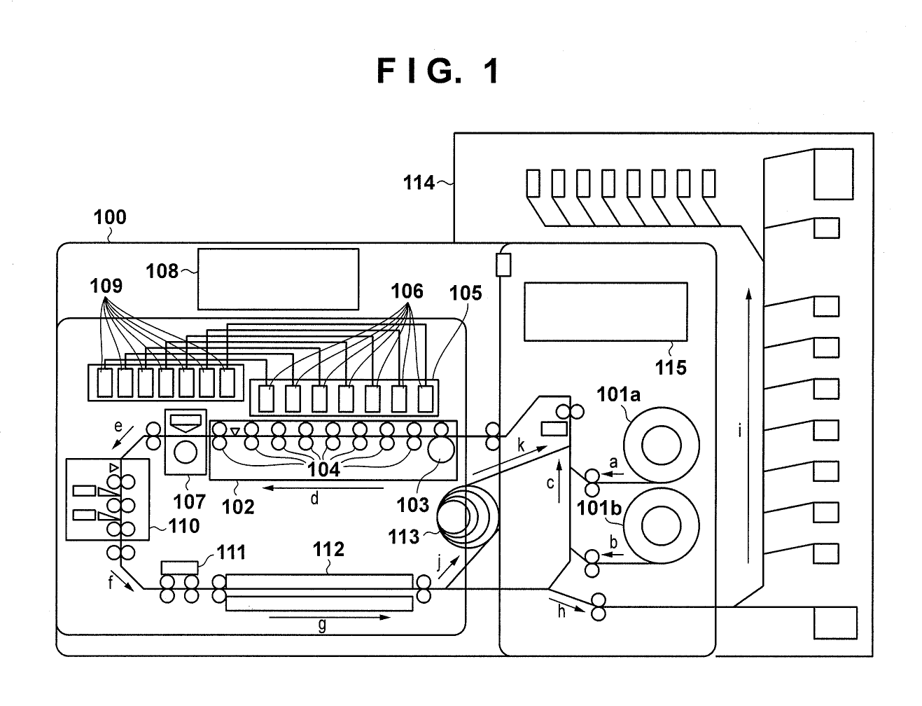

FIG. 1 is a view exemplifying the arrangement of a printing apparatus 100 according to the first embodiment of the present invention.

The printing apparatus 100 prints on a printing medium (for example, roll paper). Note that roll paper will be exemplified, but the printing medium is not limited to the roll paper.

The printing apparatus 100 includes a roll paper unit 101, a conveying unit 102, a conveying encoder 103, rotating rollers 104, a head unit 105, printheads 106, a scanner unit 107, and a control unit 108. In addition, the printing apparatus 100 includes ink tanks 109, a cutter unit 110, a back surface printing unit 111, a drying unit 112, a sheet take-up unit 113, a sorting unit 114, and an operation unit 115.

The control unit 108 includes a controller, a user interface, and various I/O interfaces, and manages control in the printing apparatus 100.

The roll paper unit 101 includes cartridges (upper cassette 101a and lower cassette 101b). The operator sets roll paper (to be also referred to as a sheet) in a magazine. A sheet fed from the upper cassette 101a is conveyed in a direction a in FIG. 1, and a sheet fed from the lower cassette 101b is conveyed in a direction b in FIG. 1. A sheet from either cassette unit is conveyed in a direction c in FIG. 1, and reaches the conveying unit 102. By using a plurality of rotating rollers 104, the conveying unit 102 coveys the sheet to be printed by the head unit 105 in a direction d (horizontal direction) in FIG. 1.

The head unit 105 is arranged above the conveying unit 102 to face it. In the head unit 105, the independent printheads 106 are arranged in the sheet conveying direction by the number of colors (seven colors in the embodiment). The printing apparatus 100 causes the printhead 106 to discharge ink in synchronism with conveyance of the sheet by the conveying unit 102. Accordingly, an image is formed and printed on the sheet. The conveying unit 102, head unit 105, and printhead 106 form a printing unit.

The ink tanks 109 independently store inks of respective colors. Ink is supplied from the ink tank 109 via a tube to a sub-tank arranged in correspondence with each color. The ink is supplied from the sub-tank to the printhead 106 via a tube.

The printheads 106 are arranged for respective colors (seven colors in the embodiment) in the direction d. Note that the arrangement of the printheads 106 is not particularly limited, and the printheads 106 may be configured by arranging a single chip or arranging a plurality of chips in a staggered pattern or in line. It suffices to arrange nozzles in a direction perpendicular to the conveying direction in order to cover the printing width of a sheet to be used (full-line head). Also, the ink discharge method is not particularly limited, and may be any one of a method using heat generation elements, a method using piezoelectric elements, a method using electrostatic elements, and a method using MEMS elements.

The nozzles of each head discharge ink. The ink discharge timing is determined based on an output signal from the conveying encoder 103.

After printing on a sheet, the sheet is conveyed from the conveying unit 102 to the scanner unit 107. The scanner unit 107 reads an image or special pattern printed on the sheet, confirms whether the printed image has a problem, and confirms the apparatus state. The image confirmation method is, for example, a method of reading a pattern for confirming the head state, or a method of comparing a printed image with an original image.

The sheet conveyed from the scanner unit 107 is conveyed in a direction e, and cut into a length of a predetermined unit by the cutter unit 110. The sheet conveyed from the cutter unit 110 is conveyed in a direction f and reaches the back surface printing unit 111. The back surface printing unit 111 prints information (for example, order management number) of each image on the back surface of the sheet.

After that, the drying unit 112 heats, by warm air, the sheet passing in a direction g in FIG. 1. Sheets cut into a length of the predetermined unit pass one by one through the drying unit 112, are conveyed in a direction h, and reach the sorting unit 114.

The sorting unit 114 stacks sheets having passed through the unit in a direction i in FIG. 1 on a tray having a number set for each image while checking the sheets using a sensor. The sorting unit 114 holds a plurality of trays, and determines a tray to stack sheets in accordance with the sheet length. Further, the sorting unit 114 displays the state such as “during stacking” or “completion of stacking” (for example, displays it using an LED).

When performing double-sided printing, printing is performed on the front surface of a sheet, and the sheet take-up unit 113 takes up the sheet passing in a direction j without cutting the sheet. After the end of printing all front surface images, the sheet is cut only once, and the taken-up sheet is conveyed in a direction k and back surface images are printed.

The operation unit 115 is a user interface (operator panel) for performing an operation by the operator and confirming the apparatus state. The operator designates apparatus maintenance such as head cleaning via the operation unit 115. The operator confirms the apparatus state via the operation unit 115, for example, a tray on which a designated order image is stacked.

The printing apparatus 100 has been explained. Note that the embodiment will explain an inkjet method as the printing method of the printing apparatus, but the present invention is not limited to this. A thermal printer (for example, sublimation or thermal transfer printer), dot impact printer, LED printer, laser printer, or the like is also available.

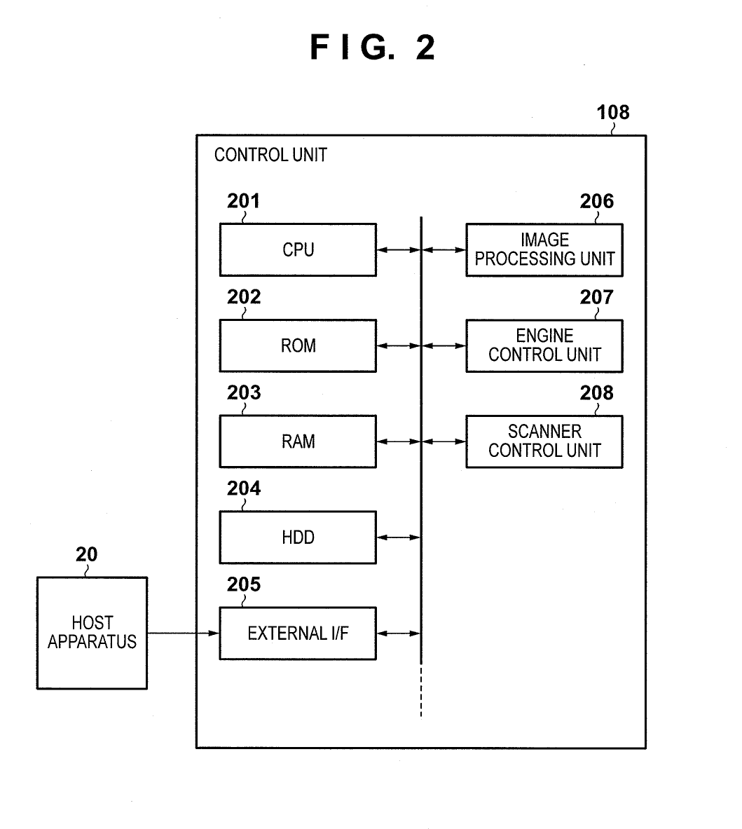

A hardware configuration in the control unit 108 shown in FIG. 1 will be exemplified with reference to FIG. 2.

The control unit 108 includes a CPU (Central Processing Unit) 201, ROM (Read Only Memory) 202, RAM (Random Access Memory) 203, HDD (Hard Disk Drive) 204, external I/F (InterFace) 205, image processing unit 206, engine control unit 207, and scanner control unit 208.

The CPU 201 executively controls processes in the control unit 108. The ROM 202 stores control programs and various data. The RAM 203 stores a print job list and work data. The HDD 204 temporarily stores image data rasterized based on a print job. The external I/F 205 receives a print job and the like from a host apparatus 20. For example, a print job transmitted from the host apparatus 20 is received via the external I/F 205. Information of the print job is stored in the print job list in the RAM 203, and image data rasterized based on the print job is stored in the HDD 204. Note the print job includes print data, control commands, and the like.

The image processing unit 206 executes rendering processing (RIP: Raster Image Processing) based on a print job. As a result, image data is generated for each page. The image processing unit 206 performs various image processes such as color space conversion, resolution conversion into an effective pixel count, image analysis, and image correction, as needed. Image data (RIPed data) obtained by image processing by the image processing unit 206 is stored in the HDD 204 or the like.

The engine control unit 207 controls the above-described printing unit based on image data to print on a sheet. For example, the engine control unit 207 issues an ink discharge instruction to the printhead 106 of each color, sets a discharge timing to adjust the dot position on a sheet, and acquires the head driving state. The engine control unit 207 controls to drive the printhead 106 in accordance with image data, and controls the printhead 106 to discharge ink, thereby printing on a sheet. In addition, the engine control unit 207 controls driving of various rollers (for example, paper feed roller and conveying roller) to convey a sheet at a proper speed and stop it.

The scanner control unit 208 controls an image sensor (for example, CCD or CIS) to read an image on a sheet. The scanner control unit 208 acquires red (R), green (G), and blue (B) analog luminance data as image read values. Further, the scanner control unit 208 analyzes the luminance data acquired from the image sensor and, for example, detects a discharge failure nozzle and sheet cutting position.

The host apparatus 20 is arranged outside the printing apparatus 100 and functions as a print job supply source. The host apparatus 20 may be a computer which performs creation of data such as an image regarding printing, or an image reader.

The external I/F 205 transmits/receives print jobs, other commands, status signals, and the like between the printing apparatus 100 and the host apparatus 20 and the like.

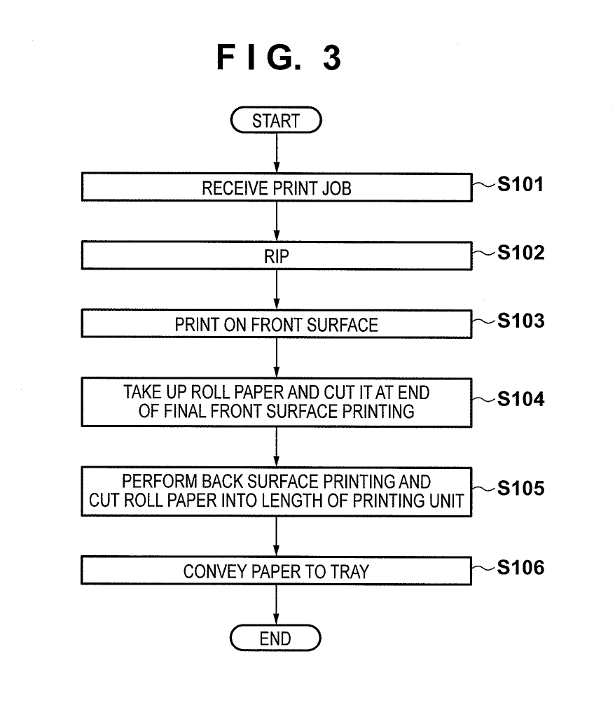

A processing sequence in the printing apparatus 100 shown in FIG. 1 will be exemplified briefly with reference to FIG. 3. A processing sequence when performing double-sided printing will be explained.

This processing starts when the printing apparatus 100 receives a print job from the host apparatus 20 via the external I/F 205 (step S101). After the start of this processing, the printing apparatus 100 controls the image processing unit 206 to RIP the received print job (step S102). The RIP order is determined based on the priority (normal or interrupt), the paper binding method, paper sizes prepared in the apparatus, the unit of stacking on the sorter tray, and the like. The data having undergone RIP is stored as RIPed data in the HDD 204.

The printing apparatus 100 controls the engine control unit 207 to start printing on the front surface of a sheet based on RIPed data for the front surface. More specifically, the printing apparatus 100 feeds a sheet from the roll paper unit 101, and controls the conveying unit 102 to convey the sheet to the head unit 105. The printing apparatus 100 prints an image on the front surface of the sheet conveyed to the head unit 105 (step S103), and conveys the printed sheet to the scanner unit 107. The printing apparatus 100 controls the scanner unit 107 to confirm the printed image, and then conveys the printed sheet to the cutter unit 110.

At this time, the printing apparatus 100 controls continuous sheet to pass through the drying unit 112 without cutting the sheet by the cutter unit 110. After drying the printed image, the printing apparatus 100 controls the sheet take-up unit 113 to take up the continuous sheet. The printing apparatus 100 performs this operation till the end of printing all RIPed data for which front surface printing is designated. Finally, the printing apparatus 100 cuts the continuous sheet (step S104).

After the end of printing on the front surface, the printing apparatus 100 controls the engine control unit 207 to start printing on the back surface of the sheet based on RIPed data for the back surface. More specifically, the printing apparatus 100 reverses the front surface-printed sheet taken up by the sheet take-up unit 113, and controls the conveying unit 102 to convey the reversed sheet to the head unit 105. The printing apparatus 100 prints a printing-designated image on the back surface of the sheet conveyed to the head unit 105 in correspondence with the front surface, and conveys the sheet to the scanner unit 107.

The printing apparatus 100 controls the scanner unit 107 to confirm the printed image, and conveys the printed sheet to the cutter unit 110. The printing apparatus 100 controls the cutter unit 110 to cut the sheet into every length of a printing unit (step S105). After the sheet passes through the drying unit 112 and is dried, the printing apparatus 100 conveys the sheet to the sorting unit 114, and conveys it to a tray designated for each image (step S106).

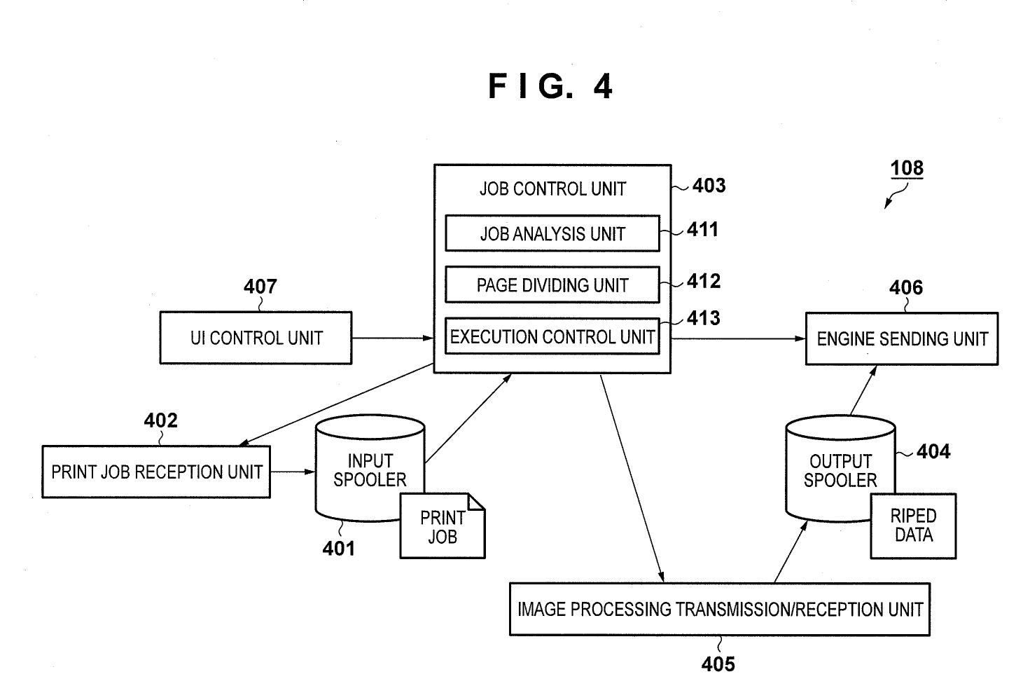

A functional arrangement implemented by the control unit 108 shown in FIG. 1 will be exemplified with reference to FIG. 4. A RIP-related functional arrangement will be exemplified.

The control unit 108 includes, as functional components, an input spooler 401, print job reception unit 402, job control unit 403, output spooler 404, image processing transmission/reception unit 405, and UI control unit 407. The components other than the input spooler 401 and output spooler 404 can be implemented by, for example, executing programs stored in the ROM 202, HDD 204, or the like by the CPU 201. Note that the input spooler 401 and output spooler 404 are implemented by the HDD 204 or the like.

The print job reception unit 402 receives a print job sent from the host apparatus 20.

The input spooler 401 stores the print job received by the print job reception unit 402. The print job is temporarily stored in the input spooler 401 in correspondence with parameter information indicating the order of input to the input spooler 401, or the like.

The job control unit 403 executively controls processes regarding the print job. The job control unit 403 includes, as functional components, a job analysis unit 411, page dividing unit 412, and execution control unit 413. The job analysis unit 411 analyzes the print job stored in the input spooler 401, and determines the job priority, paper size for use, paper type, single/double-sided printing, and the like. The page dividing unit 412 divides the print job into respective pages. The execution control unit 413 determines an optimal RIP order for the print job.

The image processing transmission/reception unit 405 transmits the print job to the image processing unit 206 in the RIP order based on an instruction from the job control unit 403. The image processing transmission/reception unit 405 stores RIPed data rasterized by the image processing unit 206 in the output spooler 404. When printing of the print job ends normally or cancellation is designated, the image processing transmission/reception unit 405 deletes the RIPed data from the output spooler 404.

The output spooler 404 stores the RIPed data. For descriptive convenience, the input spooler 401 and output spooler 404 are shown as separate components, but may be implemented as one component.

An engine sending unit 406 sends the RIPed data to the engine control unit 207 based on an instruction from the job control unit 403. When all pages are printed normally, the job control unit 403 deletes the print job from the input spooler 401.

The UI control unit 407 inputs an instruction from the user into the apparatus via the operation unit 115, and controls display of various kinds of information on the operation unit 115. An instruction from the operator is, for example, an instruction to change the priority of a print job when he wants to print based on the print job prior to a normal one, or cancel an input print job.

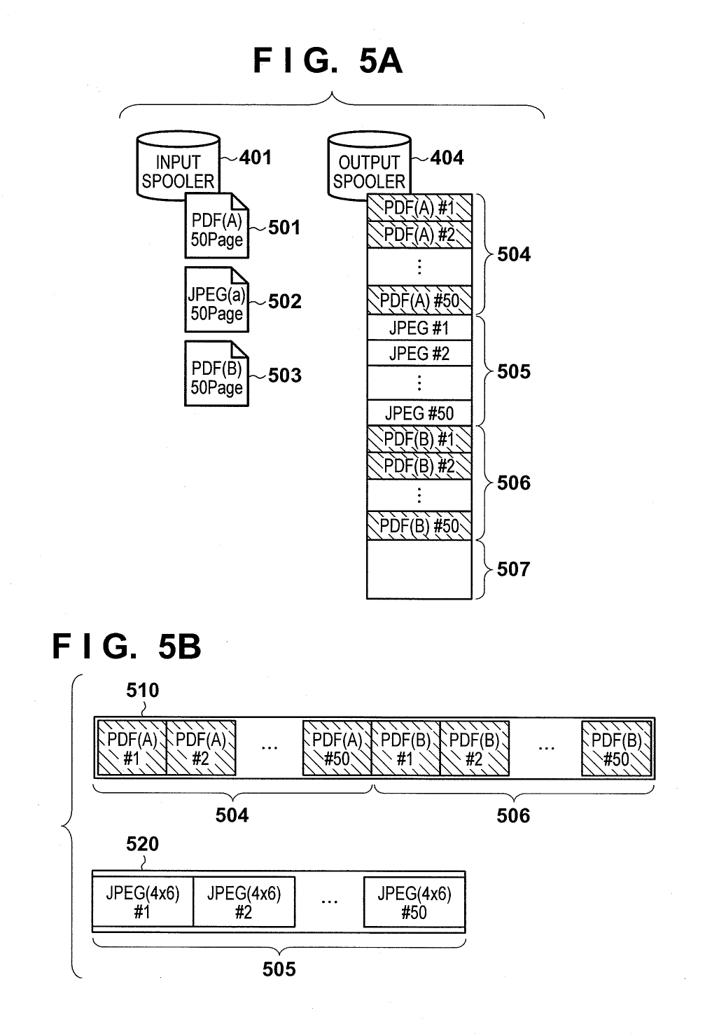

A print job control method in the job control unit 403 shown in FIG. 4 will be exemplified with reference to FIGS. 5A and 5B.

In FIG. 5A, a plurality of print jobs are input to the input spooler 401, RIPed, and stored as RIPed data in the output spooler 404.

Print jobs 501, 502, and 503 are input to the input spooler 401 in the order named. The print jobs 501 and 503 use the same size and paper type. Thus, printing based on the print jobs 501 and 503 can be performed continuously on the same sheet. The print job 502 designates a size and paper type different from those of the print jobs 501 and 503. Hence, printing based on the print job 502 cannot be performed on the same sheet as that of the print jobs 501 and 503.

RIPed data 504 to 506 are generated by RIPing the print jobs 501 to 503, respectively. Note that a free area 507 is the free area of the output spooler 404, and represents that there is room for an area for storing RIPed data.

Assume that printing is executed based on the RIPed data 504 to 506. In this case, output results on sheets 510 and 520 in FIG. 5B are obtained.

Printing based on the RIPed data 504 and 506 is continuously performed on the same roll paper (sheet 510). After printing based on the RIPed data 504 and 506, the sheet is changed, and printing based on the RIPed data 505 is performed on another sheet (sheet 520).

In this case, the print job execution order is changed to continue printing using the same sheet for the sake of high total throughput. If no print job execution order is changed, that is, printing is executed in the order of the print jobs 501, 502, and 503, printing based on the print job 501 is performed, then the sheet is changed, and printing based on the print job 502 is performed on another sheet. After that, the sheet is further changed, and printing based on the print job 503 is performed.

If printing based on the print job 503 using the same sheet as that of the print job 501 is executed prior to the print job 502, as shown in FIG. 5B, the sheet is changed only once. To the contrary, if printing is performed in the input order of print jobs to the input spooler 401, the sheet needs to be changed twice and an overhead occurs by the time taken to change the sheet, decreasing the total throughput. In this way, when printing on roll paper, it is sometimes preferable to change the print job execution order so as to continuously use the same sheet.

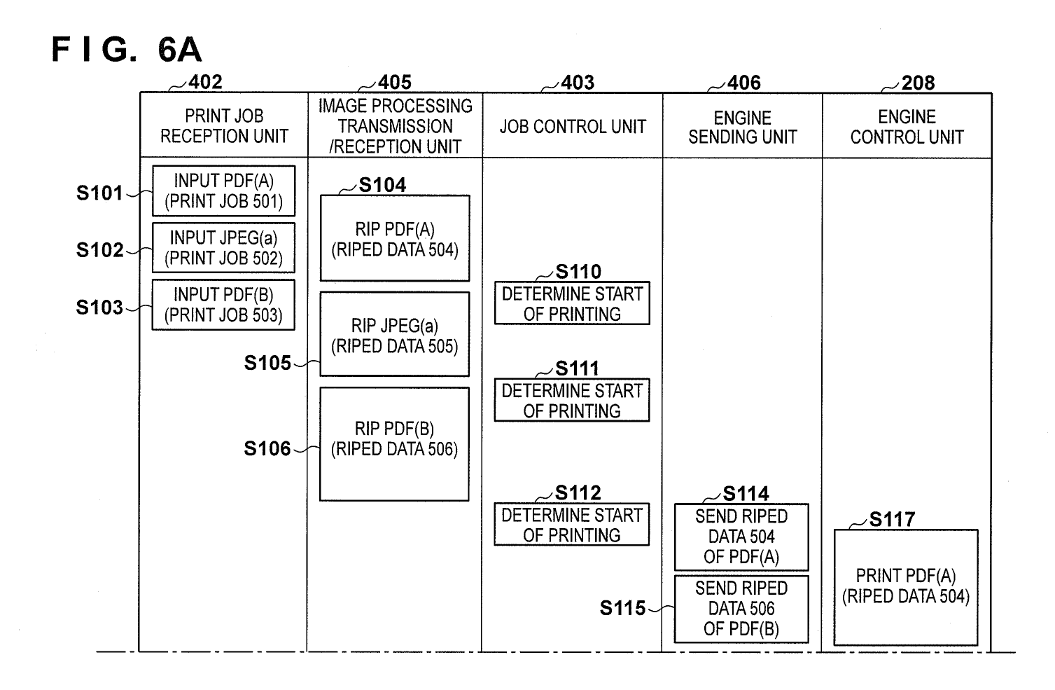

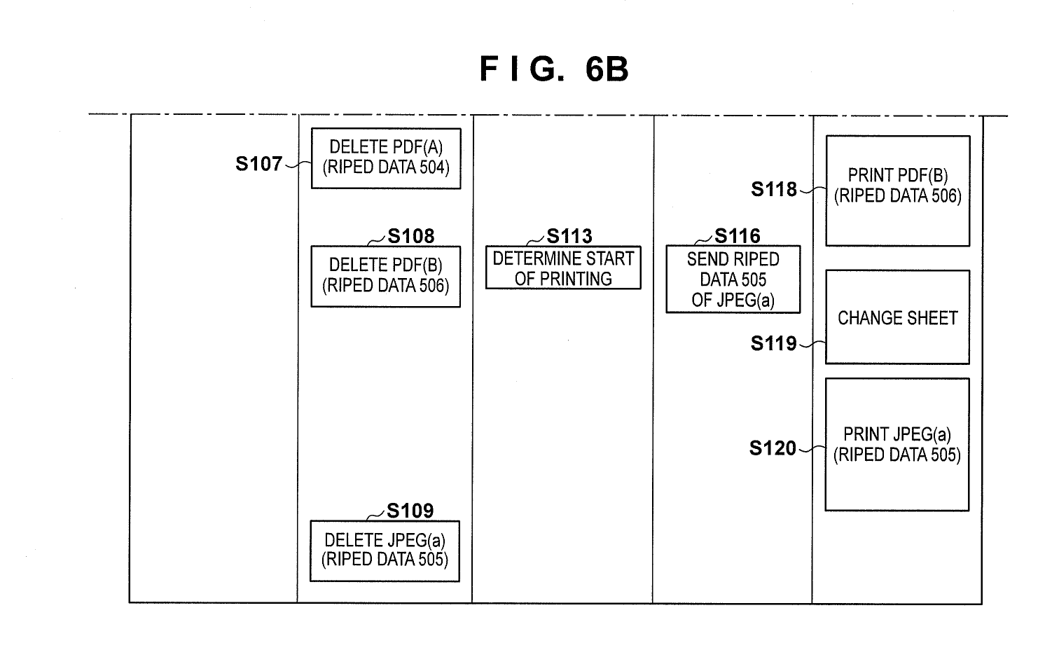

A processing sequence for the print jobs 501 to 503 will be exemplified with reference to FIGS. 6A and 6B. Note that the ordinate represents the time axis.

First, processing in the print job reception unit 402 will be explained. The printing apparatus 100 controls the print job reception unit 402 to sequentially receive the print jobs 501 to 503 and store them in the input spooler 401 (steps S101 to S103).

Next, processing in the image processing transmission/reception unit 405 will be explained. The printing apparatus 100 controls the image processing transmission/reception unit 405 to transmit, to the image processing unit 206, the print job 501 input to the input spooler 401 at the same time as input of the job. The print job 501 is rasterized (RIPed), generating RIPed data. The printing apparatus 100 then controls the image processing transmission/reception unit 405 to store the RIPed data in the output spooler 404 (step S104). The print job 502 is RIPed at the end of RIPing the print job 501 (step S105). The print job 503 is RIPed at the end of RIPing the print job 502 (step S106). Also in this case, the RIPed data based on the rasterized print jobs 502 and 503 are stored in the output spooler 404.

Upon completion of printing based on the print job 501, the image processing transmission/reception unit 405 deletes the RIPed data from the output spooler 404 (step S107). More specifically, at the same time as completion of printing based on the RIPed data generated from the print job 501, the image processing transmission/reception unit 405 deletes the RIPed data corresponding to the print job 501 serving as the rasterization source. This processing is executed in the same way even upon completion of printing based on the print jobs 502 and 503 (steps S108 and S109).

Processing in the job control unit 403 will be explained. After RIPing each print job, the printing apparatus 100 controls the job control unit 403 to determine whether to start printing at the timing when the RIPed data 504 is stored in the output spooler 404 (step S110). At this time, the print jobs 502 and 503 have been input to the input spooler 401 in addition to the print job 501, and printing based on these print jobs may be executable continuously. Thus, the job control unit 403 determines to keep the start of printing waiting until the print job 503 is RIPed.

The same determination is made even at the timing when the RIPed data 505 is stored in the output spooler 404. Also in this case, the job control unit 403 determines to keep the start of printing waiting until the print job 503 is RIPed (step S111).

The same determination is made even at the timing when the RIPed data 506 is stored in the output spooler 404 (step S112). In this case, no new print job has been input, and there is no more continuously printable print job even if printing waits furthermore. Hence, the job control unit 403 determines to start printing, and instructs the engine sending unit 406 to start printing. At this time, the job control unit 403 designates printing based on the print jobs 501 and 503 because printing based on the print jobs 501 and 503 can be performed on the same sheet.

The job control unit 403 determines whether to start printing based on the print job 502 at the timing when printing based on the print jobs 501 and 503 is complete (step S113). In this case, no new print job has been input, and there is no more continuously printable print job even if printing waits furthermore. Therefore, the job control unit 403 determines to start printing, and instructs the engine sending unit 406 to start printing.

Next, processing in the engine sending unit 406 will be explained. Upon receiving the printing instruction from the job control unit 403, the engine sending unit 406 sends the RIPed data 504 corresponding to the print job 501 to the engine control unit 207 (step S114). After the end of sending the RIPed data 504, the engine sending unit 406 sends the RIPed data 506 corresponding to the print job 503 to the engine control unit 207 (step S115). Note that the RIPed data 505 corresponding to the print job 502 is sent to the engine control unit 207 at the timing when printing based on the print job 503 is complete (step S116).

Subsequently, processing in the engine control unit 207 will be described. Upon receiving the RIPed data 504, the engine control unit 207 starts printing based on the RIPed data 504 (step S117). Upon completion of printing based on the RIPed data 504, the engine control unit 207 starts printing based on the RIPed data 506 (step S118). Upon completion of printing based on the RIPed data 504 and 506, the engine control unit 207 notifies the job control unit 403 via the engine sending unit 406 of the completion of printing.

Then, the engine'control unit 207 executes sheet change (step S119). After the end of sheet change, the engine control unit 207 starts printing based on the RIPed data 505 (step S120). Upon completion of printing based on the RIPed data 505, the engine control unit 207 notifies the job control unit 403 via the engine sending unit 406 of the completion of printing.

In this fashion, the job control unit 403 sometimes controls printing in an order different from the order in which print jobs have been received, in order to increase the total throughput.

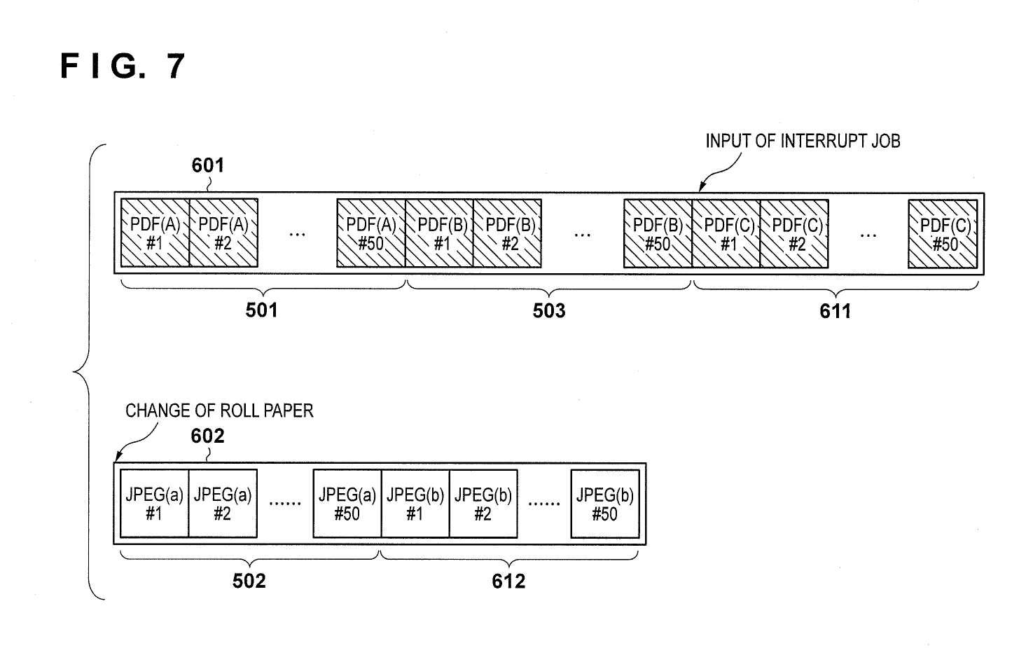

A case in which after inputting the print jobs 501 to 503, additional print jobs are input during processing of these print jobs will be explained with reference to FIG. 7. A case in which a print job (to be referred to as a normal job) 612 using the same sheet as that of the print job 502 and a high-priority print job (to be referred to as an interrupt job) 611 using the same sheet as that of the print jobs 501 and 503 are additionally input will be explained.

Sheets 601 and 602 represent images to be printed on them. Note that the sheets 601 and 602 are different in at least size.

On the sheet 601, images based on the interrupt job 611 are printed after images based on the print jobs 501 and 503. On the sheet 602, images based on the normal job 612 are printed after images based on the print job 502. In this case, after the print jobs 501 and 503 are input, images based on the interrupt job 611 are printed on the same sheet as that for printing based on the print jobs 501 and 503. As a result, an overhead generated by sheet change can be decreased, and printing based on a high-priority print job can be performed without decreasing the total throughput.

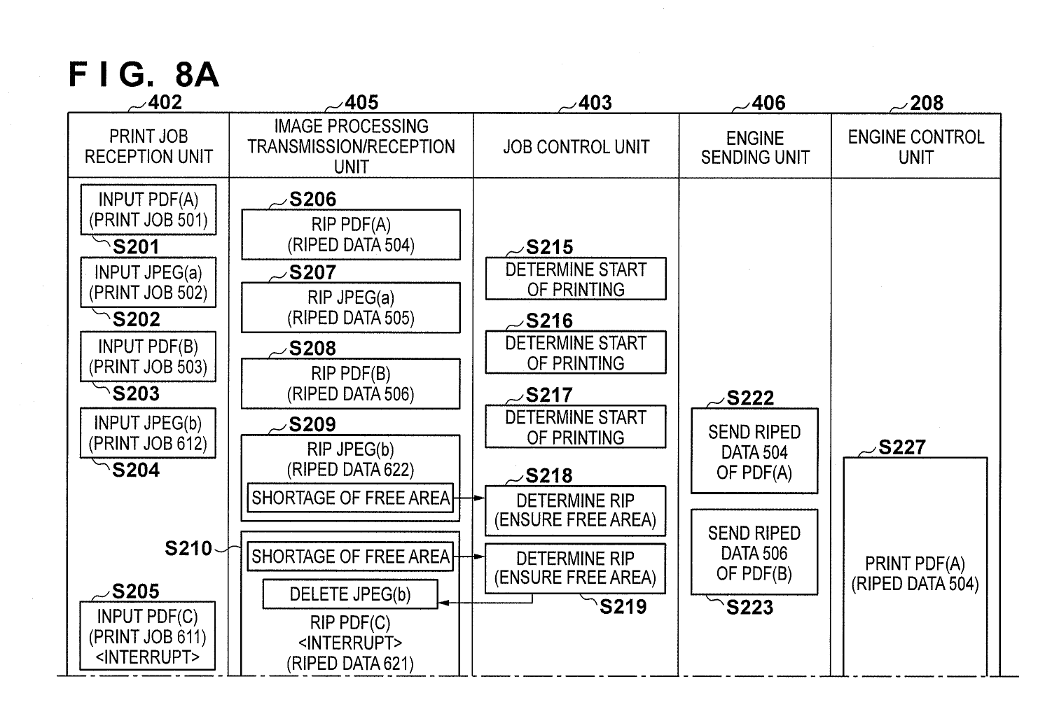

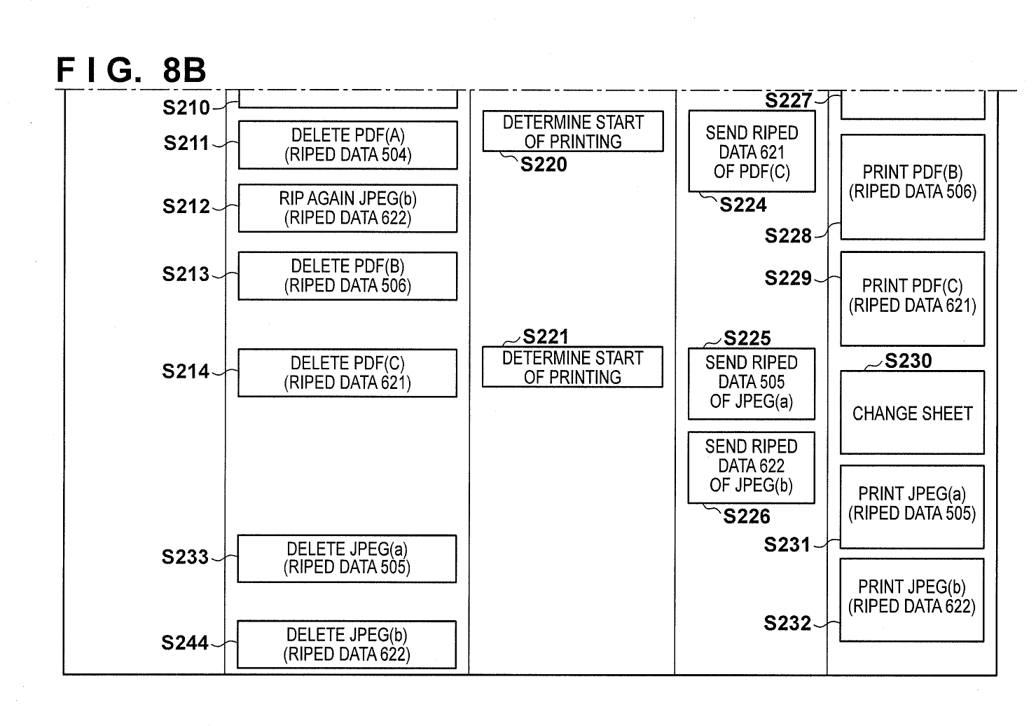

A case in which after inputting the print jobs 501 to 503, the additional print jobs 611 and 612 are input during processing of these print jobs will be explained with reference to FIGS. 8A and 8B. Note that the ordinate represents the time axis.

First, processing in the print job reception unit 402 will be explained. The printing apparatus 100 controls the print job reception unit 402 to sequentially receive the print jobs 501 to 503 and the print job 612 and store them in the input spooler 401 (steps S201 to S204). Further, the printing apparatus 100 controls the print job reception unit 402 to receive the print job 611 as an interrupt job and store it in the input spooler 401 (step S205).

Next, processing in the image processing transmission/reception unit 405 will be explained. The printing apparatus 100 controls the image processing transmission/reception unit 405 to transmit, to the image processing unit 206, the print job 501 input to the input spooler 401 at the same time as input of the job. The print job 501 is RIPed, and the image processing transmission/reception unit 405 stores the RIPed data in the output spooler 404 (step S206). The print job 502 is RIPed at the end of RIPing the print job 501 (step S207). The print job 503 is RIPed at the end of RIPing the print job 502 (step S208).

After the end of RIPing the print job 503, the print job 612 is RIPed. Assume that the free area runs short when storing RIPed data 622 of the print job 612 in the output spooler 404 (step S209). Then, the image processing transmission/reception unit 405 notifies the job control unit 403 of the shortage of the free area.

Also when RIPing the print job 611, the free area in the output spooler 404 has run short similarly. The image processing transmission/reception unit 405 notifies the job control unit 403 of the shortage of the free area. At this time, the image processing transmission/reception unit 405 receives an instruction from the job control unit 403 to delete the RIPed data 622. In response to this, the image processing transmission/reception unit 405 deletes the RIPed data 622 from the output spooler 404 (step S210).

Upon completion of printing based on the print job 501, the image processing transmission/reception unit 405 deletes the RIPed data from the output spooler 404 (step S211). As a result, a free area is ensured in the output spooler 404, and the image processing transmission/reception unit 405 transmits again, to the image processing unit 206, the print job 612 which has been deleted before. Accordingly, the RIPed data 622 based on the print job 612 is stored in the output spooler 404 (step S212). Similar to the processing in step S211, the RIPed data stored in the output spooler 404 is deleted upon completion of printing (steps S213, S214, S233 and S244).

Processing in the job control unit 403 will be explained. The printing apparatus 100 controls the job control unit 403 to determine whether to start printing at the timing when the RIPed data 504 is stored in the output spooler 404 (step S215).

At this time, the print jobs 502 and 503 have been input to the input spooler 401 in addition to the print job 501. Similar to the above description of FIGS. 6A and 6B, the job control unit 403 determines to keep the start of printing waiting until the print job 503 is RIPed. The same determination is made even at the timing when the RIPed data 505 is stored in the output spooler 404. Also in this case, the job control unit 403 determines to keep the start of printing waiting until the print job 503 is RIPed (step S216).

The same determination is made even at the timing when the RIPed data 506 is stored in the output spooler 404 (step S217). In this case, no print job capable of printing on the same sheet has been newly input, and there is no more continuously printable print job even if printing waits furthermore. For this reason, the job control unit 403 determines to start printing, and instructs the engine sending unit 406 to start printing. At this time, the job control unit 403 designates printing based on the print jobs 501 and 503 because printing based on the print jobs 501 and 503 can be performed on the same sheet.

Since the job control unit 403 is notified that the free area runs short during RIP (rendering processing) of the normal job 612, it determines whether to cancel RIP. The normal job 612 is a print job having normal priority, so the job control unit 403 does not perform processing particularly (step S218).

Also when the job control unit 403 is notified that the free area runs short during RIP of the interrupt job 611, it determines whether to cancel RIP in the above-described way. To ensure, in the output spooler 404, a free area necessary to RIP the interrupt job 611, the job control unit 403 instructs the image processing transmission/reception unit 405 to delete the RIPed data 622 of the normal job 612 (step S219). If the job control unit 403 receives, from the image processing transmission/reception unit 405, a notification that a free area is ensured, it instructs again the image processing transmission/reception unit 405 to RIP the deleted print job 612. That is, the job control unit 403 controls the image processing unit 206 to RIP the print job 612 again.

The job control unit 403 determines whether to start printing at the timing when RIPed data 621 of the interrupt job 611 is stored in the output spooler 404 (step S220). At this time, printing based on the interrupt job 611 can be executed continuously on the sheet during printing now. Therefore, the job control unit 403 designates the start of printing based on the interrupt job 611.

Further, the job control unit 403 determines whether to start printing at the timing when printing based on the print jobs 501, 503, and 611 is complete (step S221). At this time, the print job 502 and normal job 612 have been RIPed, and no new print job has been input. Hence, the job control unit 403 instructs the engine sending unit 406 to start printing based on the print job 502 and normal job 612.

Next, processing in the engine sending unit 406 will be explained. Upon receiving the printing instruction from the job control unit 403, the engine sending unit 406 sends the RIPed data 504 corresponding to the print job 501 to the engine control unit 207 (step S222). After the end of sending the RIPed data 504, the engine sending unit 406 sends the RIPed data 506 corresponding to the print job 503 to the engine control unit 207 subsequently (step S223). The engine sending unit 406 performs the same processing as the above-described one even for the remaining RIPed data based on printing instructions from the job control unit 403 (steps S224 to S226).

Processing in the engine control unit 207 will be described. Upon receiving the RIPed data 504, the engine control unit 207 starts printing based on the RIPed data 504 (step S227). Upon completion of printing based on the RIPed data 504, the engine control unit 207 starts printing based on the RIPed data 506 and 621 (steps S228 and S229). Upon completion of printing based on the RIPed data 504, 506, and 621, the engine control unit 207 notifies the job control unit 403 via the engine sending unit 406 of the completion of printing.

Thereafter, the engine control unit 207 executes sheet change (step S230). After the end of sheet change, the engine control unit 207 starts printing based on the RIPed data 505 and 622 (step S231). Upon completion of printing based on the RIPed data 505 and 622, the engine control unit 207 notifies the job control unit 403 via the engine sending unit 406 of the completion of printing.

In this manner, the job control unit 403 sometimes controls printing in an order different from the order in which print jobs have been received, in order to increase the total throughput.

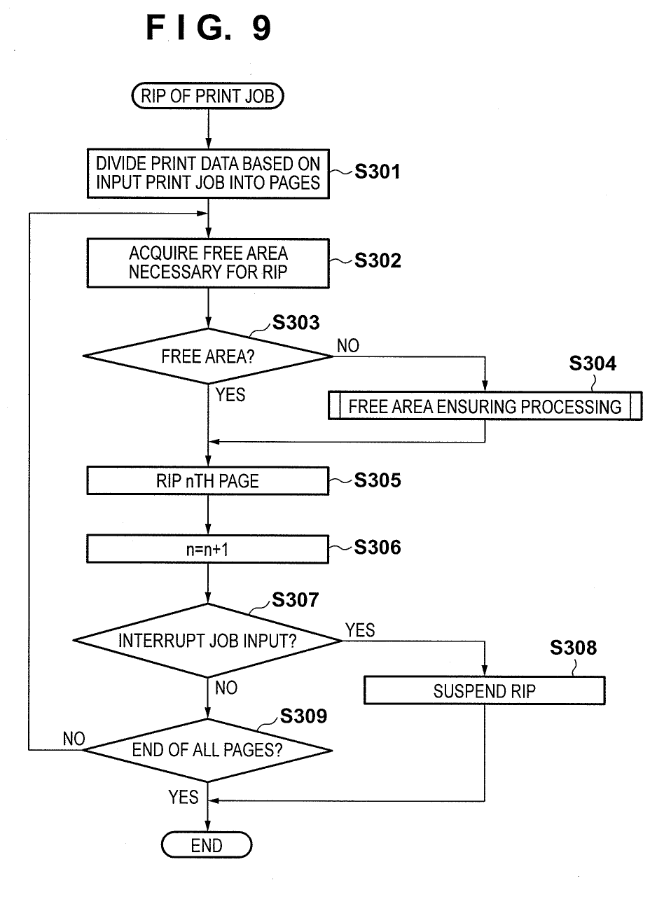

A processing sequence in the printing apparatus 100 shown in FIG. 1 will be exemplified with reference to FIGS. 9 to 11. A processing sequence in the job control unit 403 will be explained here.

A processing sequence when RIPing a print job will be exemplified with reference to FIG. 9.

This processing starts when at least one print job is input and all data necessary for RIP are obtained. After the start of this processing, the job control unit 403 repetitively executes processes in steps S301 to S309 until all the pages of the input print job are processed.

First, the job control unit 403 divides the input print job into respective pages so that the input print job can be processed for the respective pages (step S301). Then, the job control unit 403 acquires a free area necessary to store RIPed data in the output spooler 404 (step S302).

If there is no free area (NO in step S303), the job control unit 403 executes free area ensuring processing (step S304) to ensure a free area in the output spooler 404, details of which will be described later. If there is a free area (YES in step S303), the job control unit 403 instructs the image processing transmission/reception unit 405 to RIP the n (initial value=1)-th page (step S305). In response to this, the image processing transmission/reception unit 405 requests image processing of the image processing unit 206, and after the end of image processing based on the request, stores the result as RIPed data in the output spooler 404. Thereafter, the job control unit 403 increments n by “1” (step S306).

The job control unit 403 determines whether an interrupt job has been input to the input spooler 401. If an interrupt job has been input (YES in step S307), the job control unit 403 suspends RIP (step S308), and shifts to processing of the interrupt job. Note that whether to suspend RIP may be switched depending on whether a print job during processing is an interrupt job or a normal-priority print job.

If no interrupt job has been input (NO in step S307), the job control unit 403 determines whether the above-described processing has ended for all pages. If the processing has not ended for all pages (NO in step S309), the job control unit 403 performs the processes in steps S302 to S306 again; if YES in step S309, ends the processing.

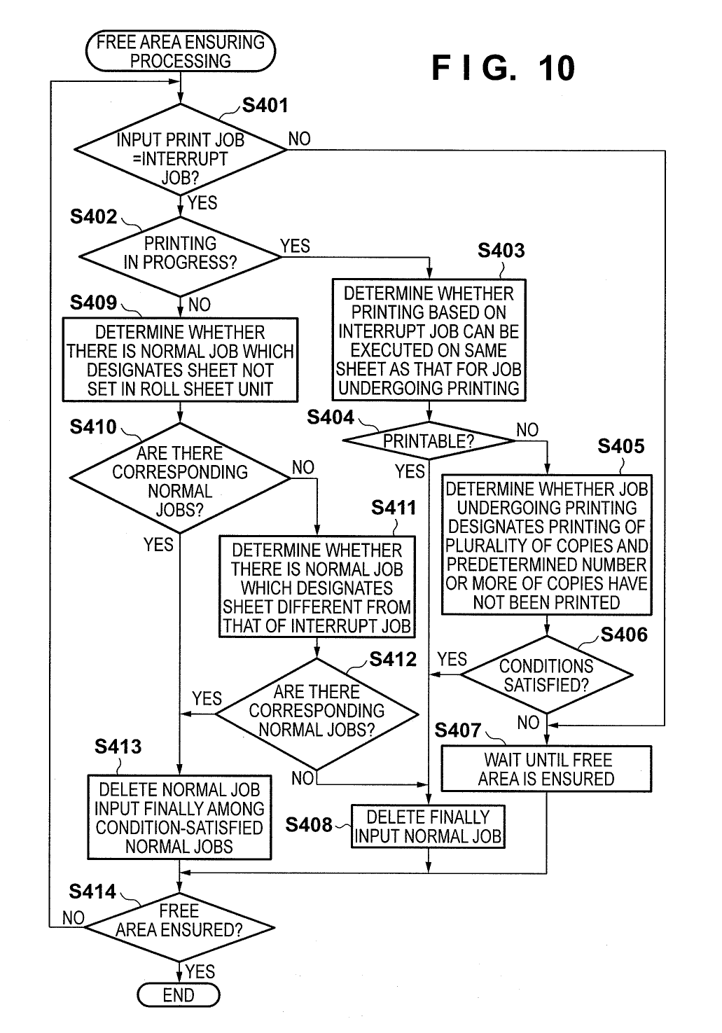

The sequence of free area ensuring processing (RIP determination processing) in step S304 of FIG. 9 will be exemplified with reference to FIG. 10. This processing corresponds to steps S218 and S219 in FIG. 8A.

After the start of processing, the job control unit 403 determines whether the input print job is an interrupt job. If the job control unit 403 determines that the input print job is not an interrupt job (NO in step S401), it waits until a free area is ensured in the output spooler 404 (step S407).

If the input print job is an interrupt job (YES in step S401), the job control unit 403 determines whether printing is in progress. In this case, it is determined that printing is in progress after the timing when RIPed data is transmitted to the engine sending unit 406.

If the job control unit 403 determines that printing is in progress (YES in step S402), it determines whether printing based on the interrupt job can be performed on the same sheet as that of the print job undergoing printing (step S403). If printing is possible (YES in step S404), the job control unit 403 instructs the image processing transmission/reception unit 405 to cancel a finally input normal job (step S408). Upon receiving the cancellation instruction, the image processing transmission/reception unit 405 deletes RIPed data of all the pages of the normal page from the output spooler 404.

If the job control unit 403 determines in step S403 that printing is impossible (NO in step S404), it determines whether the print job undergoing printing designates a plurality of copies and a predetermined number or more of copies have not been printed yet (step S405). If these conditions are satisfied (YES in step S406), the job control unit 403 instructs the image processing transmission/reception unit 405 to cancel a finally input normal job (step S408). If these conditions in step S405 are not satisfied (NO in step S406), the job control unit 403 waits until a free area is ensured in the output spooler 404 (step S407).

If the job control unit 403 determines that printing is not in progress (NO in step S402), it determines whether a normal job which designates a sheet not set in the roll paper unit 101 has been RIPed (step S409). If there are corresponding normal jobs (YES in S410), the job control unit 403 instructs the image processing transmission/reception unit 405 to cancel a normal job input finally among the corresponding (condition-satisfied) normal jobs (step S413). Upon receiving the cancellation instruction, the image processing transmission/reception unit 405 deletes RIPed data of all the pages of the corresponding normal job from the output spooler 404.

If the job control unit 403 determines in step S409 that there is no corresponding normal job (NO in S410), it determines whether a normal job which designates a sheet different in size from the interrupt job has been RIPed (step S411). If there are corresponding normal jobs (YES in S412), the job control unit 403 instructs the image processing transmission/reception unit 405 to cancel a normal job input finally among the corresponding (condition-satisfied) normal jobs (step S413).

If there is no normal job which satisfies the condition in step S411 (NO in S412), the job control unit 403 instructs the image processing transmission/reception unit 405 to cancel a finally input normal job (step S408).

After that, the job control unit 403 repetitively executes the processes in steps S401 to S413 until a necessary free area is ensured in the output spooler 404 (NO in step S414). If a necessary free area is ensured (YES in step S414), the job control unit 403 ends the processing.

The free area ensuring processing has been described. However, the processing need not always be performed in the above-described way and may be changed appropriately. For example, in the processing of step S408, a finally input normal job is canceled, but a job may be selected according to any criterion (for example, small/large capacity) and canceled. Also in the processing of step S413, not a normal job input finally among corresponding (condition-satisfied) normal jobs, but any one of corresponding normal jobs may be canceled according to any criterion. In addition, the number of normal jobs to be canceled is not limited to one, and a plurality of normal jobs may be canceled simultaneously.

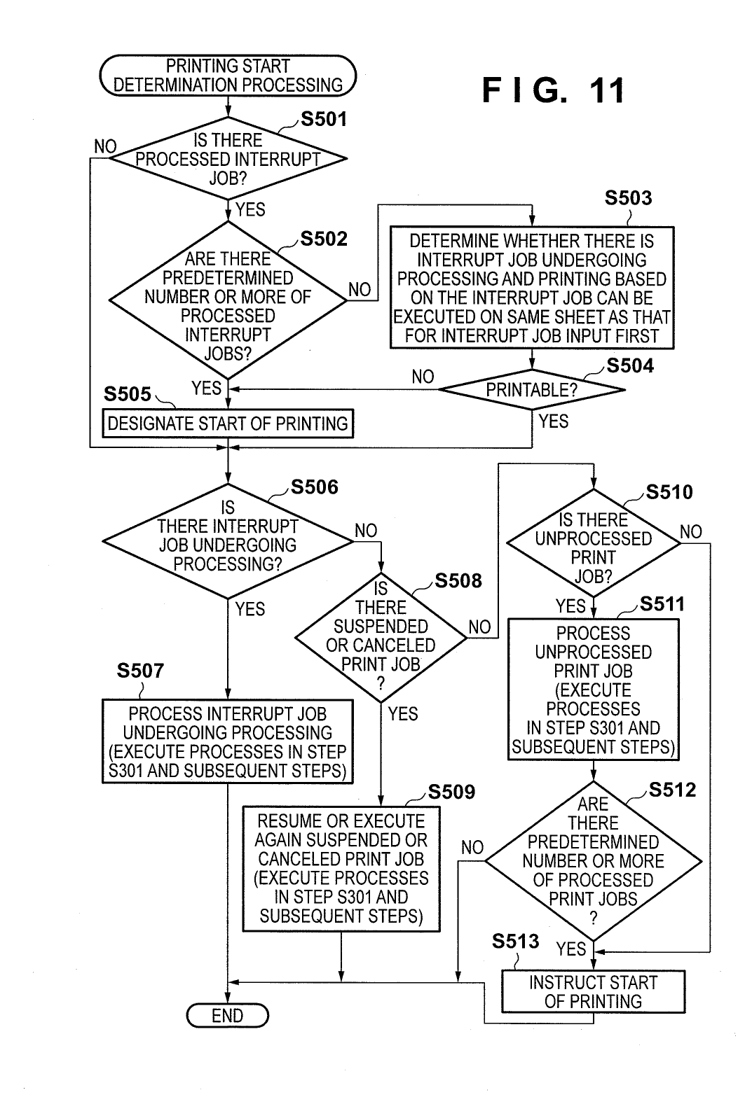

The sequence of printing start processing will be exemplified with reference to FIG. 11. This processing corresponds to steps S215 to S217 in FIG. 8A, and S220 and S221 in FIG. 8B. This processing starts at the timing when RIP of a print job shown in FIG. 10 ends. Even at the timing when printing based on a print job ends, this processing is called and executed (processing in S113 of FIG. 6B or step S221 of FIG. 8B).

After the start of this processing, the job control unit 403 determines whether there is a processed interrupt job. More specifically, the job control unit 403 determines whether RIPed data of an interrupt job has been stored in the output spooler 404. If there is no processed interrupt job (NO in step S501), the job control unit 403 advances to processing in step S506 to determine whether there is an interrupt job during processing.

If there is a processed interrupt job (YES in step S501), the job control unit 403 determines whether a predetermined number or more of RIPed data of the interrupt job have been stored in the output spooler 404. The predetermined number suffices to be at least one, and the value of the predetermined number is determined based on the performance of the image processing unit 206 or engine control unit 207.

If the job control unit 403 determines that a predetermined number or more of RIPed data of the interrupt job have been stored (YES in step S502), it transmits the RIPed data of the interrupt job to the engine sending unit 406 and designates the start of printing (step S505). If the job control unit 403 determines in step S502 that a predetermined number or more of RIPed data of the interrupt job have not been stored (NO in step S502), it determines whether there is an interrupt job undergoing processing and printing based on the interrupt job can be performed on the same sheet as that of a processed interrupt job to be printed first (step S503).

If printing based on the interrupt job cannot be performed on the same sheet (NO in step S504), the job control unit 403 transmits the RIPed data of the interrupt job to the engine sending unit 406 and designates the start of printing (step S505). If printing based on the interrupt job can be performed on the same sheet (YES in step S504), the job control unit 403 determines whether there is an interrupt job during processing.

If the job control unit 403 determines that there is an interrupt job undergoing processing (YES in step S506), it processes the interrupt job during processing. More specifically, the job control unit 403 executes the above-described processing shown in FIG. 9 for the interrupt job. Accordingly, RIPed data of the interrupt job is created (step S507). The job control unit 403 then ends the processing. If another interrupt further occurs during processing of the interrupt job, one final interrupt job may be selected and processed. The order in which a plurality of interrupt jobs are processed may be properly changed in accordance with user settings or the like. For example, the first interrupt job may be selected and processed.

If the job control unit 403 determines in step S506 that there is no interrupt job undergoing processing (NO in step S506), it determines whether there is a suspended or canceled print job. If there is a suspended or canceled print job (YES in step S508), the job control unit 403 processes the print job. More specifically, the job control unit 403 executes the above-described processing shown in FIG. 9 for the print job. As a result, RIPed data of the print job is created (step S509). The job control unit 403 then ends the processing.

If there is no suspended or canceled print job (NO in step S508), the job control unit 403 determines whether there is an unprocessed print job. More specifically, the job control unit 403 determines whether a print job has been input to the input spooler 401.

If the job control unit 403 determines that there is no unprocessed print job (NO in step S510), it transmits the RIPed data to the engine sending unit 406 and instructs the start of printing (step S513).

If there is an unprocessed print job (YES in step S510), the job control unit 403 executes the above-described processing shown in FIG. 9 for the unprocessed print job. More specifically, RIPed data of the unprocessed print job is created (step S511). The job control unit 403 determines whether a predetermined number or more of processed print jobs, that is, RIPed data have been stored in the output spooler 404. The predetermined number suffices to be at least one, and the value of the predetermined number is determined based on the performance of the image processing unit 206 or engine control unit 207.

If the job control unit 403 determines that a predetermined number or more of processed print jobs have not been stored (NO in step S512), it ends the processing. If a predetermined number or more of processed print jobs have been stored (YES in step S512), the job control unit 403 transmits the RIPed data to the engine sending unit 406 and designates the start of printing (step S513). After that, the job control unit 403 ends the processing.

As described above, according to the first embodiment, when an interrupt job (job higher in priority than a normal job) is input during processing of a normal job and there is no free area in the output spooler 404, the normal job having low priority is canceled, and printing based on the interrupt job is executed first. Even if there is no free area when interrupt printing is requested, the interrupt printing can be processed quickly.

Since a print job to be canceled is selected to perform printing using the same sheet as continuously as possible, even the total throughput does not decrease. Further, the printing start timing is adjusted, so both execution of an interrupt job and maintenance of the printing throughput can be achieved.

### Second Embodiment

The second embodiment will be described. The second embodiment will explain a case in which a processing delay due to shortage of a free area is considered even for data (page data) output by page dividing processing, in addition to the first embodiment.

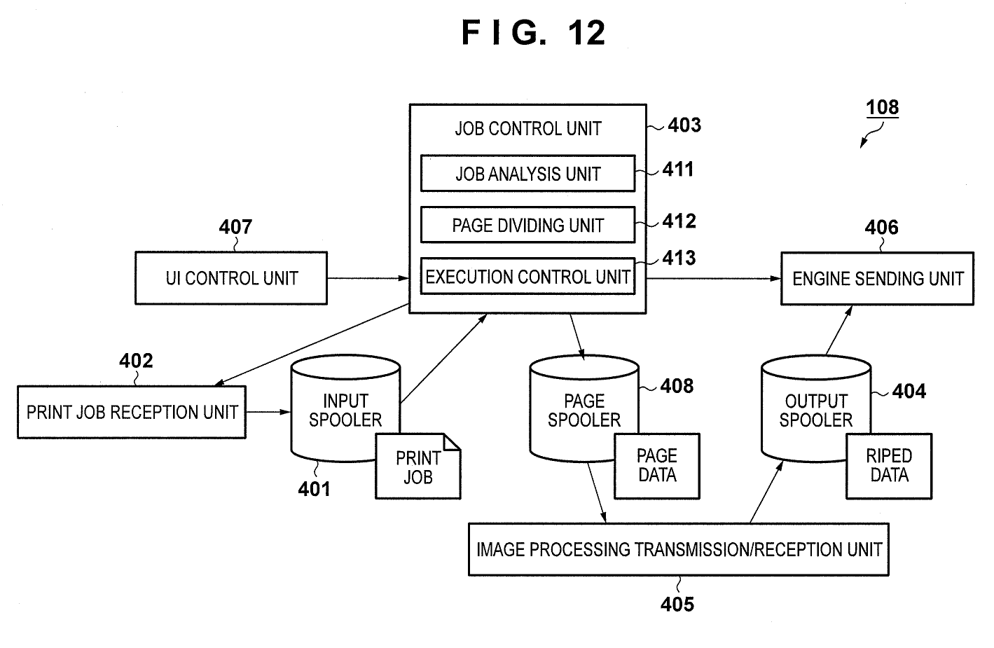

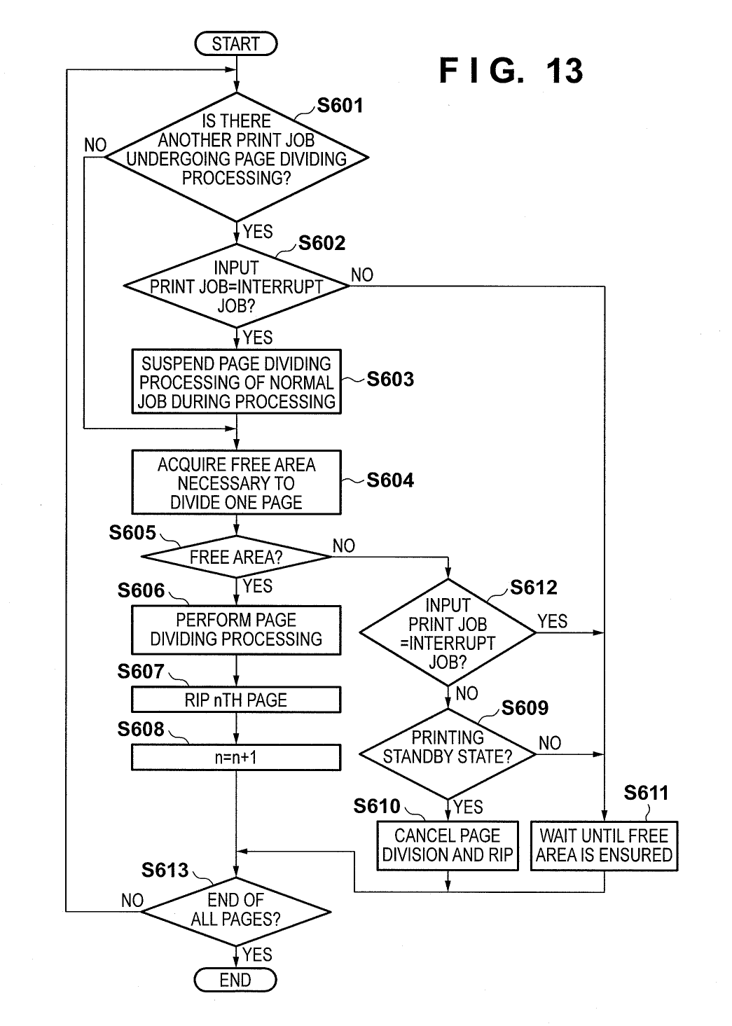

A functional arrangement implemented by a control unit 108 according to the second embodiment will be exemplified with reference to FIG. 12. A RIP-related functional arrangement will be exemplified. Note that the same reference numerals as those in the arrangement of FIG. 4 described in the first embodiment denote the same functions, and a description thereof will not be repeated in some cases.

The control unit 108 includes a page spooler 408 in addition to the arrangement of FIG. 4 described in the first embodiment.

The page spooler (page data storage unit) 408 stores data (page data) divided into respective pages. For descriptive convenience, an input spooler 401, an output spooler 404, and the page spooler 408 are shown as separate components, but may be implemented as one component. Note that the page spooler 408 is implemented by an HDD 204 or the like. An image processing transmission/reception unit 405 transmits page data to an image processing unit 206 based on an instruction from a job control unit 403.

A processing sequence in a printing apparatus 100 according to the second embodiment will be exemplified with reference to FIG. 13. A processing sequence when dividing a print job into respective pages and performing RIP will be explained. This processing is performed instead of the processing of FIG. 9 described in the first embodiment. After the end of the processing shown in FIG. 13, printing start determination processing described with reference to FIG. 11 is executed.

This processing starts when at least one print job is input and all data necessary for RIP are obtained. After the start of this processing, the job control unit 403 repetitively executes processes in steps S601 to S612 until all the pages of the input print job are processed.

First, the job control unit 403 determines whether there is another print job undergoing page dividing processing. If there is no other print job undergoing page division (NO in step S601), the job control unit 403 advances to processing in step S604. If there is another print job undergoing page division (YES in step S601), the job control unit 403 determines whether the newly input print job is an interrupt job.

If the job control unit 403 determines that the newly input print job is not an interrupt job but a normal job (NO in step S602), it waits until a free area is ensured in the page spooler 408 (step S611). For example, when a print job is RIPed and stored as RIPed data in the output spooler 404, or RIP is canceled, the created print data is deleted and a free area is ensured in the page spooler 408. If a free area is ensured, the job control unit 403 resumes the suspended page dividing processing (NO in step S613).

If the job control unit 403 determines in step S602 that the newly input print job is an interrupt job (YES in step S602), it suspends processing for the print job during page dividing processing (step S603). Note that the job control unit 403 need not always suspend the print job during page dividing processing, and may wait for the end of processing.

The job control unit 403 acquires a free area necessary to divide one page (step S604). If the page spooler 408 has a free area corresponding to the necessary area (YES in step S605), the job control unit 403 executes page dividing processing for the newly input print job, and stores the page data in the page spooler 408 (step S606).

Subsequently, the job control unit 403 RIPs page data of the n (initial value=1)-th page, and stores it as RIPed data in the output spooler 404 (step S607). The job control unit 403 increments n by “1” (step S608). If the output spooler 404 does not have a free area necessary for RIP, the job control unit 403 may cancel RIPed data or wait until a free area is ensured, according to the processing described with reference to FIG. 11.

If the job control unit 403 determines in step S605 that the page spooler 408 does not have a free area (NO in step S605), it determines whether the newly input print job is an interrupt job. If the newly input print job is an interrupt job (YES in step S612), the job control unit 403 waits until a free area is ensured in the page spooler 408 (step S611).

If the newly input print job is not an interrupt job but a normal job (NO in step S612), the job control unit 403 determines whether the current state is a state (to be referred to as printing standby) in which no printing can be executed even if RIPed data are fully prepared. The printing standby state is, for example, a state in which RIP is completed during the night and printing on a sheet stops.

If the current state is the printing standby state (YES in step S609), the job control unit 403 cancels (stops) page dividing processing and RIP for the input print job (normal job). More specifically, the job control unit 403 simultaneously deletes page data created midway in the page spooler 408 based on the normal job, and RIPed data created midway in the output spooler 404 based on the normal job (step S610). In the page spooler 408, page data is deleted after RIP, generating a free area. However, when the free area in the output spooler 404 runs out and RIP does not proceed any more, the free area in the page spooler 408 also runs out as well as the output spooler 404. For this reason, the job control unit 403 executes the above-mentioned cancellation to ensure a free area in the page spooler 408 and perform page dividing processing.

If the job control unit 403 determines in step S609 that the current state is not the printing standby state (NO in step S609), it waits until a free area is ensured in the page spooler 408. After the wait, the job control unit 403 determines whether the above-described processing has ended for all pages. If the processing has not ended for all pages (NO in step S613), the job control unit 403 performs the processes in steps S601 to S612 again; if YES in step S613, ends the processing.

As described above, the second embodiment can prevent a printing delay of an interrupt job due to shortage of a free area by canceling RIP even for page data generated by page dividing processing.

Typical embodiments of the present invention have been described. However, the present invention is not limited to the above-described and illustrated embodiments, and can be properly modified and practiced within the gist of the invention.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-014386 filed on Jan. 26, 2011, which is hereby incorporated by reference herein in its entirety.

What is claimed is:

1. A printing apparatus comprising:
a reception unit configured to receive print data;
an image processing unit configured to execute rendering processing based on page data generated from the print data and rasterize the page data into image data;
a storage unit configured to store the image data rasterized by said image processing unit; and
a control unit configured to, when a free area in said storage unit runs short in rasterization of first print data into image data, delete, from said storage unit, image data of second print data which designates a printing medium different from a printing medium on which the first print data is to be printed.

2. The apparatus according to claim 1, further comprising a determination unit configured to determine priority of the print data,
wherein when the free area in said storage unit runs short in rasterization of the first print data into image data, said control unit deletes, from said storage unit, image data of second print data which designates a printing medium different from a printing medium on which the first print data is to be printed, and is lower in priority than the first print data.

3. The apparatus according to claim 1, further comprising a plurality of cartridges configured to hold printing media,
wherein said control unit deletes, from said storage unit, image data of second print data which designates a printing medium held in a cartridge different from a cartridge holding a printing medium on which the first print data is to be printed.

4. The apparatus according to claim 1, wherein when the free area in said storage unit runs short in rasterization of the second print data into image data, said control unit controls the rasterization processing to wait until a free area is ensured in said storage unit.

5. The apparatus according to claim 1, wherein in deletion of the image data, said control unit deletes, from said storage unit, image data of second print data which designates a printing medium not set in the printing apparatus.

6. The apparatus according to claim 1, wherein when said reception unit receives first print data higher in priority than the second print data during rendering processing of the second print data by said image processing unit, said control unit controls said image processing unit to suspend the rendering processing of the second print data.

7. The apparatus according to claim 1, wherein when a free area is ensured in said storage unit after deleting the image data of the second print data, said control unit controls said image processing unit to execute again the rendering processing of the second print data.

8. The apparatus according to claim 1, further comprising:
a page dividing unit configured to divide the print data received by said reception unit into page data of respective pages; and
a page data storage unit configured to store the page data divided by said page dividing unit,
wherein said image processing unit executes rendering processing for the page data stored in said page data storage unit to rasterize the page data into the image data, and
when a free area in said page data storage unit runs short in division into the page data, said control unit controls the dividing processing to wait when dividing the first print data into page data, and when dividing the second print data into page data, stops the dividing processing in a printing standby state in which no printing can be executed, and controls the dividing processing to wait in a state other than the printing standby state.

9. The apparatus according to claim 8, wherein when stopping dividing processing for the second print data, said control unit deletes the page data of the second print data from said page data storage unit, and deletes, from said storage unit, image data rasterized from the page data of the second print data.

10. A printing apparatus comprising:
a reception unit configured to receive print data;
a determination unit configured to determine priority of the print data;
a page data storage unit configured to store page data obtained by dividing the print data received by said reception unit into pages;
an image processing unit configured to execute rendering processing based on the page data and rasterize the page data into image data;
an image data storage unit configured to store the image data rasterized by said image processing unit; and
a control unit configured to, when a free area in said image data storage unit runs short in rasterization of first print data into image data, simultaneously delete, from said page data storage unit and said image data storage unit, page data obtained by dividing second print data lower in priority than the first print data, and image data rasterized from the page data.

11. A processing method for a printing apparatus, comprising:
receiving print data;
executing rendering processing based on page data generated from the print data to rasterize the page data into image data;
storing, in a storage unit, the image data rasterized in the executing rendering processing; and
when a free area in the storage unit runs short in rasterization of first print data into image data, deleting, from the storage unit, image data of second print data which designates a printing medium different from a printing medium on which the first print data is to be printed.

12. A processing method for a printing apparatus, comprising:
receiving print data;
determining priority of the print data;
dividing the print data received in the receiving print data into pages to store the divided print data as page data in a page storage unit;
executing rendering processing based on the page data to rasterize the page data into image data in an image data storage unit; and
when a free area in the image data storage unit runs short in rasterization of first print data into image data, simultaneously deleting, from the page data storage unit and the image data storage unit, page data obtained by dividing second print data lower in priority than the first print data, and image data rasterized from the page data.
